(19) United States
(12) Patent Application Publication
(10) Pub. No.: US 2018/0368334 A1
(43) Pub. Date: Dec. 27, 2018

(54) CONTAINER FOR POT CULTURE

(71) Applicant: DONGGUAN SHANGLAN TECHNOLOGY CO., LTD., Shatian (CN)

(72) Inventor: Yi WANG, Shatian (CN)

(73) Assignee: DONGGUAN SHANGLAN TECHNOLOGY CO., LTD., Shatian (CN)

(21) Appl. No.: 15/630,694

(22) Filed: Jun. 22, 2017

(51) Int. Cl. A01G 9/02

(52) U.S. Cl. CPC A01G 9/02; A01G 9/24

(57) ABSTRACT

The application comprises a container body and a recess provided at the bottom of the container body, wherein an opening of the recess is opposite to an opening of the container for pot culture, a bottom surface of the recess is at a distance of a first preset height from the bottom surface of the container body, at least one bearing platform is provided at the opening of the recess, an end of the bearing platform close to the opening of the recess is at a distance of a second preset height from the bottom surface of the container body; the second preset height is configured such that when the container for pot culture is stacked into another container for pot culture, the outer wall of the container for pot culture is not in contact with the inner wall of another container for pot culture.

### TECHNICAL FIELD

The present application relates to the technical filed of garden tools and, in particular, to a container for pot culture for growing flowers, vegetables and other plants.

### BACKGROUND

People tend to grow some plants such as flowers for ornamentation or vegetables for food in flowerpots in their lives that are usually flat-bottomed and made of plastics or porcelain with decorative patterns on the outer wall. However, such patterns are often faded or scratched in transportation as result of the frictions between inner and outer walls of flowerpots when they are stacked to save space after manufacture, which brings down their sales consequently. Meanwhile, these traditional pots once transported to gardens require a great deal of earth for flower cultivation and, following that, additional costs are necessary for transportation when these earth-filled flowerpots with flowers are delivered to flower shops.

In the prior art, D1 (CN103688786B) discloses a water collecting flowerpot comprising the lateral wall and a pot bottom; the pot bottom and the lateral wall are integrally formed; the pot bottom comprises an outer pot bottom, a middle pot bottom and an inner pot bottom; the inner pot bottom is a cone-shaped bottom surface which bulges toward an inner chamber of a pot body; the middle pot bottom is a cone-shaped bottom surface which bulges toward the inner pot bottom; outer edges of the outer pot bottom are concave downward to form an annular groove which is used for storing dipping water; water storage chambers which are formed by the inner pot bottom and the middle pot bottom are used for storing redundant water after pouring into a pot chamber; redundant water of the pot chamber permeates to the water storage chamber through a water permeable hole formed in the inner pot bottom; water-drawing micro holes which are used for absorbing water on the ground are formed in the outer pot bottom; a plurality of water-drawing pipes are arranged inside the lateral wall; water absorption cores are arranged inside the water-drawing pipes; the water-drawing pipes, the water-drawing chamber and the annular groove are communicated.

D2 (CN103749199B) involves a plastic flowerpot with ventilation and leakage-prevention functions and relates to the field of living goods. The plastic flowerpot comprises a flowerpot body. legs are arranged at the bottom of the flowerpot body, a tubular air duct is arranged at the center of the bottom surface of the flowerpot body, the upper end port of the air duct is higher than the internal bottom surface of the flowerpot body, and a water storage groove circumferentially encircling the air duct is arranged at the lower portion of the inner bottom surface of the flowerpot body; and a ventilation cover is arranged above the air duct and the water storage groove in a buckled manner.

Although the flowerpots in D1 and D2 have achieved substantial improvement over the prior art, they fail to overcome the aforesaid technical problems.

### SUMMARY

Given that, the present invention is designed to provide a container for pot culture to prevent the pattern/color fading on the containers resulting from frictions among stacked pots and affecting appearance and to use less earth over the prior art.

The present application relates to a container for pot culture, comprising a container body and a recess provided at the bottom of the container body, wherein an opening of the recess is opposite to an opening of the container for pot culture, a bottom surface of a bottom of the recess is at a distance of a first preset height from a bottom surface of a bottom of the container body, at least one bearing platform is provided at the opening of the recess, an end of the bearing platform close to the opening of recess is at a distance of a second preset height from the bottom surface of the bottom of the container body, at the second preset height, when the container for pot culture is stacked into another container for pot culture, the outer wall of the container for pot culture is not in contact with the inner wall of the another container for pot culture, and the first preset height is greater than the second preset height.

Preferably, each bearing platform protrudes from the inner wall of the recess in a corrugated manner.

Preferably, there are pluralities of bearing platforms distributed on the inner wall of the recess at an equal space.

Preferably, the recess forms a hollow lug boss within the container body, and the hollow lug boss is integrated with the bottom of the container body.

Preferably, the hollow lug boss is in a circle shape and fixing recesses are provided along the circumference of hollow lug boss, corresponding to the bearing platforms.

Preferably, preformed holes are provided on the bottom surface of the bottom of the container body surrounding the opening of the recess, wherein the preformed holes can be used for draining the container for pot culture or fixing the container for pot culture on a surface of a designated object when the preformed holes are penetrated.

Preferably, the preformed holes are screw holes through which screws extend to fix the container for pot culture on the surface of the designated object.

Preferably, a trumpet-shaped connector is provided between an end of the bearing platform close to the opening of recess and the bottom surface of bottom of the container body, wherein the connector has a maximum diameter at the opening of the recess.

Preferably, the second preset height is set between 2 cm and 8 cm.

Preferably, the outer surface of the container body is provided with a plurality of circular decorative strips.

The container for pot culture of the present application is able to prevent the pattern/color fading or scratch on the containers resulting from frictions among stacked pots and affecting appearance. Meanwhile, the recess design allows less use of earth in the pot for plant growth and thus makes them easier to carry since the weight thereof is reduced.

### BRIEF DESCRIPTION OF THE DRAWINGS

FIG. 1 is a schematic diagram showing the structure of the container for pot culture of an preferred embodiment of the present application from the front perspective;

FIG. 2 is a schematic diagram showing the section of the container for pot culture of FIG. 1;

FIG. 3 is a schematic diagram showing the top view of the container for pot culture of FIG. 1;

FIG. 4 is a schematic diagram showing the section of the two stacked containers for pot culture of the present application; and

FIG. 5 is a schematic diagram showing the structure of the recess of the two stacked containers for pot culture of FIG. 4.

### DETAILED DESCRIPTION OF THE INVENTION

To better understand the above purposes, features and advantages of the application, further descriptions are provided below in combination with figures and embodiments. It should be noted that the embodiments of the present application and features of the embodiments can be combined if they are not in contradiction.

Many details are illustrated as follows to facilitate a full understanding of the present invention. However, it can also be practiced in many other ways different from the one present here, meaning the protection scope thereof is not limited by the following embodiments.

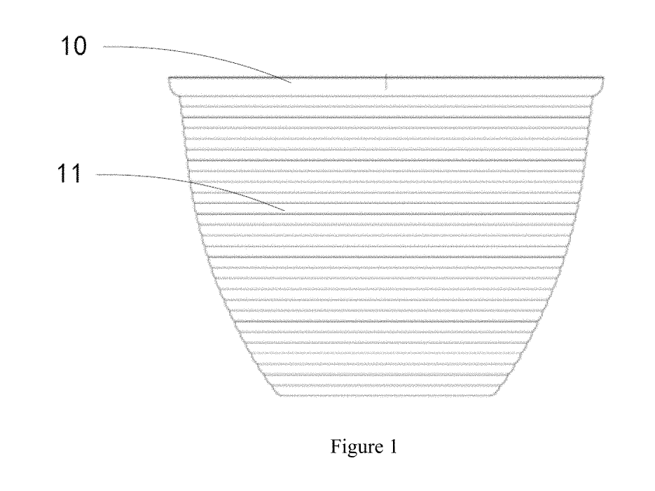

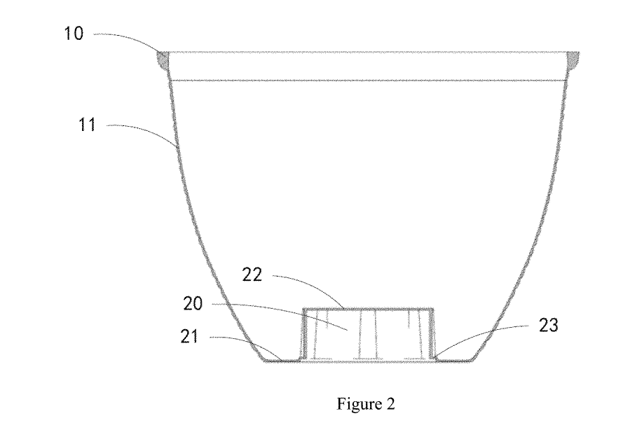

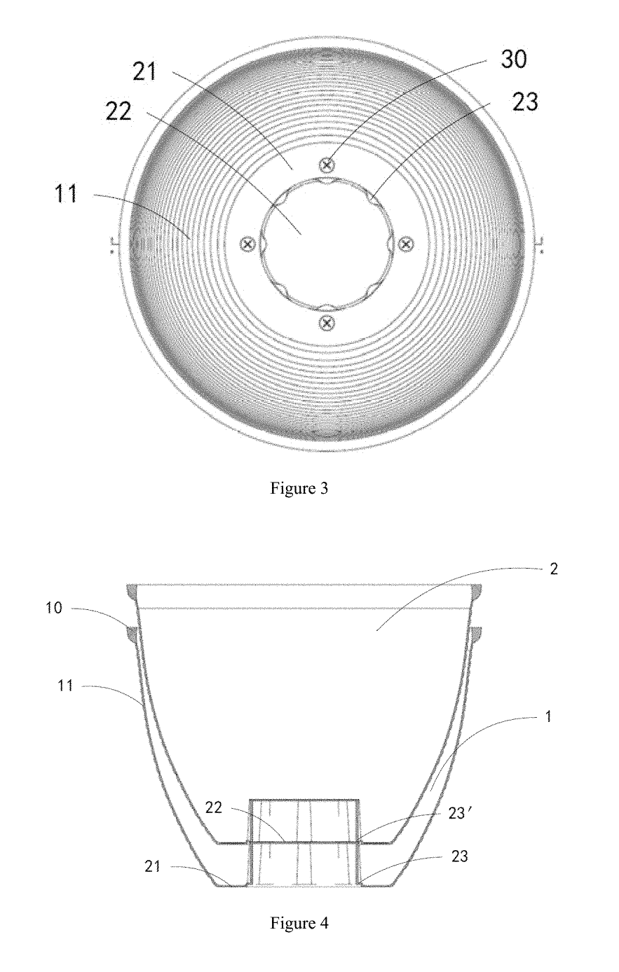

As shown in FIGS. 1-5, the container for pot culture of the present application comprises a container body 10 and a recess 20 provided at the bottom of the container body, wherein an opening of the recess 20 is opposite to the opening of the container for pot culture. A bottom surface 22 of the bottom of the recess 20 is at a distance of a first preset height from the bottom surface 21 of the bottom of the container body 10. At least one bearing platform 23 is provided at the opening of the recess 20, and an end of the bearing platform 23 close to the opening of recess 20 is at a distance of a second preset height from the bottom surface 22 of the bottom of the container body 10. The second preset height is configured such that when a first container is stacked into a second container, the outer wall of the first container is not in contact with the inner wall of the second container. The first preset height is greater than the second preset height.

The container for pot culture of the present application is, by providing the recess 20 and the bearing platform 23, able to prevent the pattern/color fading or scratch on the containers resulting from frictions between stacked containers. Meanwhile, the recess allows less use of earth in the container for plant growth and thus makes them it to carry and transport since the weight thereof is reduced.

Preferably, each bearing platform 23 protrudes from the inner wall of recess 20 in a corrugated manner.

Preferably, there are pluralities of bearing platforms 23 distributed on the inner wall of the recess 20 at an equal space.

Preferably, the recess 20 forms a hollow lug boss within the container body, and the hollow lug boss is integrated with the bottom of the container body.

Preferably, the hollow lug boss is in a circle shape and fixing grooves are provided along the circumference of hollow lug boss, corresponding to the bearing platforms. The fixing grooves are useful in fixing the bearing platforms of the containers for pot culture.

Preferably, preformed holes 30 are provided on the bottom surface of the bottom of the container body 10 which surrounds the opening of recess 20, wherein the preformed holes 30 can be potentially used for draining the container or fixing the container on the surface of a designated object when the preformed holes 30 are penetrated.

Preferably, the preformed holes 30 are screw holes through which screws extend to fix the container for pot culture on the surface of a designated object.

Preferably, a trumpet-shaped connector 24 is provided between an end of the bearing platform close to the opening of recess 20 and the bottom surface 21 of the bottom of the container body. The connector 24 has a maximum diameter at the opening of the recess.

Preferably, the second preset height is set between 2 cm and 8 cm, and preferably between 3 cm and 5 cm. This range enables two containers for pot culture to keep a proper distance from each other without occupying too much space, while preventing frictions therebetween to ensure their good appearance.

Preferably, the outer surface of container body is provided with a plurality of circular decorative strips.

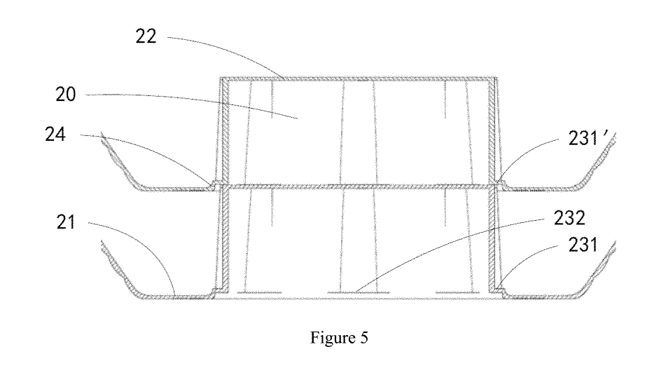

As shown in FIGS. 4 and 5, when the first container for pot culture 1 is stacked with the second container for pot culture 2, the first container for pot culture 1 comprises a bearing platform 23, a bottom surface 22 of recess 20 and a bottom surface 21 of the container body; the bearing platform 23′ of the second container for pot culture 2 contacts the bottom surface 22 of recess 20 to bear the second container for pot culture 2; and at this time the inner wall of the first container for pot culture 1 is not in contact with the outer wall of the second container for pot culture 2, ensuring no friction to decorative strips 11 of the second container for pot culture 2. FIG. 5 illustrates that the first container for pot culture 1 possesses multiple bearing platforms 231 and 232, and the bearing platform 231′ of the second container for pot culture 2 bears the bottom of the recess of the first container for pot culture 1. Connector 24 is tilted to allow the bottom of the recess of the first container for pot culture 1 to be stacked easily to the bearing platform of the second container for pot culture 2.

The above embodiments only serve as preferred embodiments of the present application, rather than limit the invention. A person skilled in the art can make various changes to and modify the present invention without departing from the scope thereof. In other words, any modification, equivalent replacement or improvement thereof should all fall into the protection scope of the present invention.

We claim:

1. A container for pot culture, comprising a container body and a recess provided at the bottom of the container body, wherein an opening of the recess is opposite to an opening of the container for pot culture, a bottom surface of a bottom of the recess is at a distance of a first preset height from a bottom surface of a bottom of the container body, at least one bearing platform is provided at the opening of the recess, an end of the bearing platform close to the opening of recess is at a distance of a second preset height from the bottom surface of the bottom of the container body, and the first preset height is greater than the second preset height, wherein the second preset height is configured such that when the container for pot culture is stacked into another container for pot culture, the outer wall of the container for pot culture is not in contact with the inner wall of the another container for pot culture, and.

2. The container for pot culture according to claim 1, wherein each bearing platform protrudes from the inner wall of the recess in a corrugated manner.

3. The container for pot culture according to claim 2, wherein there are pluralities of bearing platforms distributed on the inner wall of the recess at an equal space.

4. The container for pot culture according to claim 1, wherein the recess forms a hollow lug boss within the container body, and the hollow lug boss is integrated with the bottom of the container body.

5. The container for pot culture according to claim 4, wherein the hollow lug boss is in a circle shape and fixing recesses are provided along the circumference of hollow lug boss, corresponding to the bearing platforms.

6. The container for pot culture according to claim 5, wherein preformed holes are provided on the bottom surface of the bottom of the container body surrounding the opening of the recess, wherein the preformed holes can be used for draining the container for pot culture or fixing the container for pot culture on a surface of a designated object when the preformed holes are penetrated.

7. The container for pot culture according to claim 6, wherein the preformed holes are screw holes through which screws extend to fix the container for pot culture on the surface of the designated object.

8. The container for pot culture according to claim 1, wherein a trumpet-shaped connector is provided between an end of the bearing platform close to the opening of recess and the bottom surface of bottom of the container body, wherein the connector has a maximum diameter at the opening of the recess.

9. The container for pot culture according to claim 1, wherein the second preset height is set between 2 cm and 8 cm.

10. The container for pot culture according to claim 1, wherein the outer surface of the container body is provided with a plurality of circular decorative strips.
